(19) United States
(12) Patent Application Publication
(10) Pub. No.: US 2024/0415118 A1
(43) Pub. Date: Dec. 19, 2024

(54) Formulation for a Low Viscosity Agricultural Adjuvant Applied in a Spray Syrup

(71) Applicant: Forquimica Agrociencia LTDA, Cambira (BR)

(72) Inventors: Edson Geraldo ROSINI, Cambira (BR); Paulo Assis Dos Passos, Maringa (BR)

(21) Appl. No.: 18/815,698

(22) Filed: Aug. 26, 2024

Related U.S. Application Data
(63) Continuation-in-part of application No. 17/935,065, filed on Sep. 23, 2022, now Pat. No. 12,108,758.

(30) Foreign Application Priority Data
Apr. 14, 2022 (BR) BR 1020220073015

(51) Int. Cl. A01N 25/30; A01N 25/04; A01N 43/52; A01P 3/00; A01P 7/04; A01P 13/00

(52) U.S. Cl. CPC A01N 25/30; A01N 25/04; A01N 43/52; A01P 3/00; A01P 7/04; A01P 13/00

(57) ABSTRACT

A low viscosity agricultural adjuvant for spraying syrups containing up to 30% by weight of first grade emulsifying agents/surfactants, up to 25% by weight of second grade emulsifying agents/surfactants, up to 1.5% by weight of a suspending agent, up to 4.0% by weight of a defoamer, up to 8% by weight of clays, and water. The adjuvant, despite containing clays and surfactants, presents a balanced formulation that does not interfere negatively when mixed into syrups containing inoculants and other active biological products.

### RELATED APPLICATIONS

This application claims the priority of Brazilian Patent Application No. BR 1020220073015 filed on Apr. 14, 2022. This application is a continuation-in-part of U.S. patent application Ser. No. 17/935, 065 filed Sep. 23, 2022.

### BACKGROUND OF THE INVENTION

### 1. Field of invention

The present invention patent application is aimed at the agricultural sector, specifically in the field of spray application technology, and concerns the formulation of a multifunctional agricultural adjuvant.

### 2. Prior Art Description

Adjuvants that are sprayed onto plants have well-known functions, such as improving the wettability of the plant surface, allowing the applied drops to reach the target, and increasing spreadability over the leaves to expand the contact area. Furthermore, the adjuvant facilitates penetration through the leaf cuticle, especially important for systemic, mesostemic and translaminar products. The adjuvant reduces the formation of foam in the syrup to avoid operational problems and conditions the syrup to minimize chemical and physical interactions between molecules. The adjuvant also acts as a drift reducer, therein preventing the product from reaching unwanted areas.

In addition to these essential functions, some new adjuvant formulations have additional characteristics that make the adjuvant more compatible with inoculants and agricultural biological products. In addition, adjuvants reduce the presence of residues that can adhere to the spray system, therein improving the reach of the spray solution to the lower part of the plant. These functionalities are attributed to the product's specific formulation, which combines raw materials in precise quantities, thus promoting synergy between molecules that results in improved performance in the application of agricultural products.

The new adjuvant formulation also solves important problems, such as compatibility with biological products, which is crucial in a sustainable agricultural context, where the inoculation of beneficial microorganisms is common practice. Many of these microorganisms are sensitive to the environment, and compatibility with the solution is essential for the effectiveness of the application.

There is a need for an improved adjuvant formulation that focuses on reducing residue in sprayers, as residue retention in the system can cause damage to crops during subsequent applications, especially in the case of herbicides. The presence of residues is a critical point that can compromise the quality of the spraying and result in environmental residues that need to be discarded.

The functionality of improving the reach of the spray in the lower third of the plants is also vital, as this area is prone to the emergence of diseases due to the high humidity retention caused by the closure holding the adjuvant. Farmers can benefit by improving the efficiency of applying agricultural products and extending the useful life of equipment, from mixing in the tank to final application.

Finally, there is a need for superior conditioning of the spray and a high-performance application, resulting in a homogeneous and fluid spray, with high efficiency from the exit of the sprayer to the deposition of drops on the crop.

Application technology in agribusiness seeks to use all available scientific knowledge to ensure the application of agricultural products efficiently, economically and with the lowest possible environmental impact. As the agricultural sector is aware, an adjuvant is a product used in mixture with other products formulated to improve its application. There are several classifications of adjuvants based on their functions, and one of them identifies categories such as surfactants, oils, adhesives, drift reducers, antifoams, spray conditioners, compatibilizers, among others. There is currently a wide range of adjuvants on the market, and choosing the most appropriate one for each application is essential to guarantee effectiveness. However, different factors, such as humidity, lack of rain, penetration into waxy leaves, droplet size and chemical compatibility, must be considered, which makes it challenging and expensive to use a specific product for each need. Adjuvant formulations that are multifunctional, combine several compounds with different functions. This enables a single product to meet the main needs of an efficient application, offering innovative characteristics for an adjuvant.

With regard to the state of the art in patent registrations, documents BR 10 2019 004266-4, BR 11 2021 013322-4, BR 11 2018 005502-6 and EP 2757880B1 claim compositions containing adjuvant systems and film-forming agents for fungicide spray mixtures, methods for treating plants, liquid agricultural adjuvants, methods for diluting liquid agricultural adjuvants, emulsifiable adjuvants, and methods for manufacturing an emulsified stable pH-buffered adjuvant composition, as well as adjuvant compositions, agricultural pesticide compositions, and methods of manufacturing and use of these compositions.

Registration BR 10 2019 004266-4 describes an adjuvant composed of derivatives of Alkylpolyglucoside surfactants (APGs), combined with a dispersant/film former based on polyvinylpyrrolidone, and the use of this composition to increase the physical stability of spray mixtures, reduce to derive and improve the agronomic efficacy of contact fungicide formulations, including Mancozeb, Chlorothalonil and cupric fungicides (such as Bordeaux mixture, copper oxysulfate, copper hydroxide, copper oxychloride and cuprous oxide).

The second registration, BR 11 2021 013322-4, claims a liquid agricultural adjuvant composed of an alkyl ester (C1C8) of an alkyl acid (C12C16), an anionic surfactant and a non-ionic surfactant. This adjuvant has a flash point above approximately 100° C. and an alkyl ester (C1C8) of an alkyl acid (C12C16) with the ability to dissolve paraffin wax between 2% w/p and 20% w/p at 25° C.

The third registration, BR 11 2018 005502-6, claims a stable, self-emulsifiable alkylated oil-based adjuvant with pH buffering capabilities, adjuvant preparation methods and its use in industrial, lawn, ornamental, horticultural and agricultural applications.

Finally, the fourth registration, EP 2757880B1, claims a composition of agricultural adjuvants that includes one or more non-ionic surfactants, chosen from a group consisting of fatty acid glycol ester surfactants, triglyceride polyalkoxidated surfactants, alkoxylated fatty alcohol surfactants and sorbitan fatty acid ester surfactants, in addition to one or more anionic surfactants and polyanionic polymers.

These prior art references show adjuvant compositions intended to improve pesticide activity. However, the compounds and percentages do not coincide with the present application, where the proposed formulation of the adjuvant solves problems related to the compatibility of syrups with inoculants and other microbiological-based products, without affecting the survival of bacterial and/or fungal cells in these products. Furthermore, the adjuvant formulation keeps the equipment clean, without residues of the phytosanitary solution after application. Finally, the present invention guarantees high effectiveness in reaching the lower third of the plant, where pests and diseases develop. These functionalities solve recurring problems in agricultural application due to the mixing and reactions between the components of the formulation, carefully studied and adjusted in quantities that presented different results, both chemically and agronomically, compared to other products available on the market.

Understanding the chemical composition of the new adjuvant formulation, its functions include compatibility with inoculants in the syrup. The presence of clay in the formulation can lead to unfavorable interactions with microorganisms, such as the adsorption of the microorganism by the mineral surface of the clay, affecting the viability and microbial activity in the mixture. Clay can also inhibit microbial growth due to its ability to adsorb essential nutrients, control pH and retain water, characteristics that can have antimicrobial functions, that is, positive for the product.

Another important aspect of the present invention is its interaction of surfactants with microorganisms. Surfactants, with their surface tension reduction and emulsification properties, can cause disruption of cell membranes and inhibition of microbial growth, leading to the death or inactivation of microorganisms. Due to these properties, surfactants are often used in antimicrobial products, such as disinfectants and detergents.

Despite containing clays and surfactants, the balanced combination of these components in the adjuvant formulation does not interfere negatively when mixed in syrups containing inoculants, as demonstrated in compatibility tests with biological products.

In relation to reaching the lower third of the plant, it is widely known that the presence of surfactants in the adjuvant formulation influences the size and composition of the droplets formed during spraying. These droplets are electrostatically attracted to the lower surface of the plant, an effect that depends on the composition and combination of surfactants present in the adjuvant formulation. The electrification of the drops, promoted by ionic agents that conduct electricity and make up the proposed formulation, allows for better deposition of the spray on the targets, increasing application efficiency, especially in the lower third of the plant.

Thus, surfactants can influence target coverage, as large droplets minimize precision and very small droplets increase the risk of drift and rapid evaporation. It is therefore necessary to adjust the surfactants in the formulation to balance droplet size, avoiding drift losses and ensuring effective target hitting, as demonstrated in the target hitting tests presented in the detailed description.

### SUMMARY OF THE INVENTION

The present invention is a low viscosity agricultural adjuvant for spraying syrups containing up to 30% by weight of first grade emulsifying agents/surfactants, up to 25% by weight of second grade emulsifying agents/surfactants, up to 1.5% by weight of a suspending agent, up to 4.0% by weight of a defoamer, up to 8% by weight of clays, and water. The adjuvant, despite containing clays and surfactants, presents a balanced formulation that does not interfere negatively when mixed into syrups containing inoculants and other active biological products.

### BRIEF DESCRIPTION OF THE DRAWINGS

The present inventive activity will be described below in greater detail, by way of non-limiting examples, with reference to its preferred embodiment illustrated in the drawings below, in which:

FIG. 1 is an overview block diagram illustrating the general ingredients used to create the present invention adjuvant;

FIG. 2 is a graph illustrating the survival results of the bacterium Azospirillum brasilense in syrup in the presence of the adjuvant formulation titled with the acronym FQ in column 1 and in syrups in the presence of four other competitors in columns 2, 3, 4 and 5, after 3 hours of mixing the syrups.

FIG. 3 is a graph illustrating the survival results of the bacterium Bradyrhizobim japonicum in syrup in the presence of the FQ adjuvant formulation in column 1 and in syrups in the presence of four other competitors in columns 2, 3, 4 and 5, after 3 hours of agitation of the syrups.

FIG. 4 is a graph that shows the residues retained in the hydraulic circuit (total sum of residues in all filters) using the competing adjuvant and the FQ adjuvant formulation.

FIG. 5 is a graph that shows the percentage of coverage in the lower third of soybean plants using standard oil, the FQ adjuvant formulation and competing adjuvant.

FIG. 6 shows images of the filters removed from the sprayer after spraying for visual qualitative verification of residues.

FIG. 7 shows images of protocol code 3 before and after shaking in a Becker cup.

FIG. 8 shows images of protocol code 5 before and after shaking in a Becker cup.

FIG. 9 shows images of protocol code 7 before and after shaking in a Becker cup.

FIG. 10 depicts in the images the residue from protocol 3 retained on the sieve before the passage of running water (image on the left) and after the passage of running water (image on the right).

FIG. 11 represents in the images the residue from protocol 5 retained on the sieve before the passage of running water (image on the left) and after the passage of running water (image on the right).

FIG. 12 shows images to the residue from protocol 7 retained on the sieve before running water (image on the left) and after the passage of running water (image on the right).

### DETAILED DESCRIPTION OF THE INVENTION

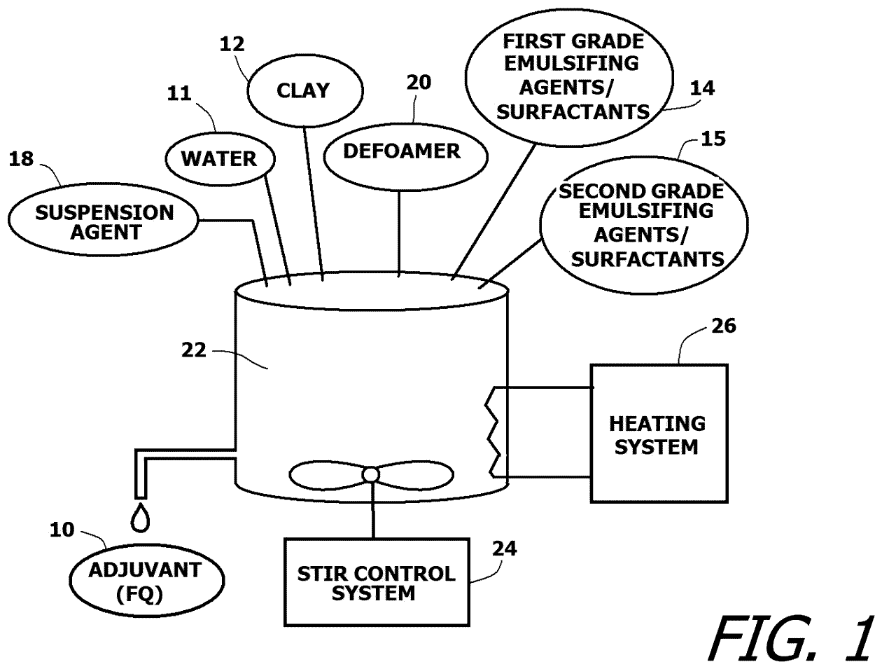

Referring to FIG. 1, it can be seen that the formulation of the adjuvant 10, entitled with the acronym “FQ”, is composed of first grade emulsifiers and surfactants 14, second grade emulsifiers and surfactants 15, suspending agents 18, defoamers 20 and clays 12. All ingredients are mixed with water 11 to form an aqueous solution. The clays 12 present in the formulation act as adsorption agents for the molecules in the mixture, facilitating a better interaction of these molecules during spraying. The technology used in the invention allows the inclusion of clays 12 without significantly increasing the viscosity of the mixture. This results in an ideal solution, which allows application without the risk of clogging the equipment nozzles. The clays 12 that can be used include sodium bentonite, attapulgite, sepiolite and/or zeolite.

The compounds used in the formulation with characteristics of first grade emulsifiers and surfactants 14 are triethanolamine lauryl ether sulfate, ethoxylated alcohol 6E0, 8E0 and 12E0, ethoxylated fatty alcohol, ethoxylated oil and linear alkylbenzene sulfonic acid.

As a source of suspending agent 18, xanthan gum can be used. The silicone-based defoamer 20 is polydimethylsiloxane.

In the Table 1 below, the percentage by weight of the compounds used in the formation of the adjuvant 10 of the present invention follows:

TABLE 1

| 1st grade emulsifiers and/or | 21 to |
|---|---|
| surfactants | 30% |
| 2nd grade emulsifiers and/or | 18 to |
| surfactants | 25% |
| Polydimethylsiloxane defoamer | 1 to 4% |
| Suspending agent xanthan gum | 0.15 to |
| | 1.5% |
| Clays ( sodium bentonite, | 2 to 8% |
| attapulgite, sepiolite and zeolite) | |
| Water | 32.8 to |
| | 56.5% |

There are first grade emulsifying 10 agents/surfactants 14 and second grade emulsifying agents/surfactants 15. The weight percentage of 21% to 30% of first grade emulsifying agents/surfactants 14 is subdivided into 18% to 20% sodium lauryl ether sulfate, 17% to 19% triethanolamine lauryl ether sulfate, 20% to 22% alcohol ethoxylated 6E0, 15% to 17% ethoxylated alcohol 8E0 and 23% to 25% ethoxylated alcohol 12E0.

The percentage by weight of 18% to 25% of second-grade emulsifying/surfactants 15 is subdivided into 35% to 37% ethoxylated fatty alcohol, 41 to 43% ethoxylated oil and 20 to 22% linear alkylbenzene sulfonic acid.

The weight percentage of 2.0 to 8.0% of clays 12 is subdivided into 23 to 25% sodium bentonites, 19 to 21% attapulgite, 37 to 39% sepiolite and 16 to 18% zeolite.

The FQ adjuvant 10 has a low viscosity liquid characteristic and the manufacturing process begins by adding water 11 to a mixer 22 of suitable volume. The mixer 22 is made of stainless steel, preferably with an agitation control system 24 and a heating system 26. With the heating system 26 on, the xanthan gum suspending agent 18 is opened, with strong agitation. After opening, the solution is cooled and the polydimethylsiloxane defoamer 20, first and second grade emulsifiers/surfactants 14, 15 are added and then the clays 12. With each addition, homogenization is carried out, waiting for the components to completely open, so that the next component can be added. Once the mixing process is complete, the adjuvant 10 with a low viscosity liquid characteristic is obtained.

### 1. Compatibility Test with Biological Products in Syrup (FQ Adjuvant Functionality Tests)

Due to considerable changes in crop management with the aim of making modern agriculture more environmentally appropriate, great appeal has been given to the practice of inoculating beneficial microorganisms in crops to promote plant growth, manage pests and diseases, and provide nutritional, among other features. Many microorganisms used in commercial products are highly sensitive to the environment. Since biological inputs are mostly composed of living organisms, and these organisms are very sensitive to the environment to which they are exposed, it is crucial that the technology for applying these inputs maintains the viability of living organisms.

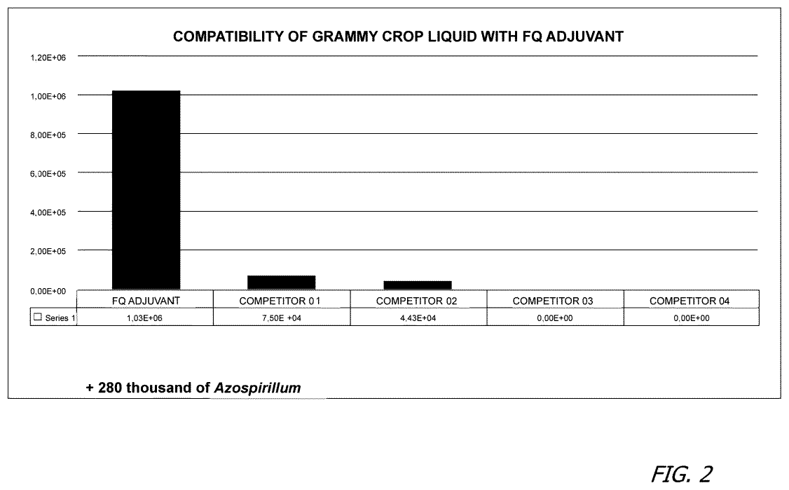

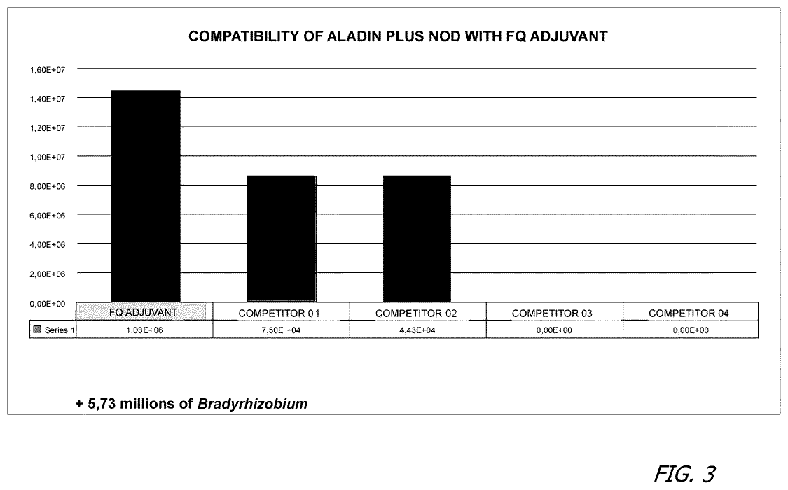

The proposed FQ adjuvant 10 was compared to other adjuvants on the market in order to demonstrate its compatibility with agricultural products based on microorganisms. 0.6 mL of Bradyrhizobim japonicum bacteria, 0.2 mL of Azospirillum brasilense bacteria and 0.24 mL of the FQ adjuvant formulation were used for a syrup volume of 160 mL of sterile deionized water (values that correspond to 80 L of syrup), prepared in 500 mL Erlenmeyer flasks for each bacteria (Graphs in FIGS. 2 and 3). After preparing the syrup, the Erlenmeyer flasks were stirred at 130 RPM for 3 hours, and then cell concentration analyzes (CFU/mL) were carried out using serial dilutions. The amount of 0.1 mL of each dilution was placed, which allowed counts of 30 to 300 colonies per plate, in YMA+Red Congo and Red Congo culture medium for B. japonicum and A. brasilense, respectively. The plates were incubated in a bacteriological oven at 28° C. for 7 -10 days for B. japonicum and 3-5 days for A. brasilense, and the colonies were counted after this period. For comparative purposes, four other competing commercial adjuvants were tested, following the manufacturer's recommendations, for the same purpose.

The products with the bacteria Bradyrhizobim japonicum and Azospirillum brasilense were evaluated for their compatibility with the FQ adjuvant formulation and four other competing commercial adjuvants, as controls. The results demonstrated that the biological products tested were not negatively affected by the formulation of the present invention. Unlike competitors, which ended up totally and partially reducing the number of viable cells in each syrup, the proposed formulation provided the greatest recovery of viable cells, while competing adjuvants led to the death of microorganisms.

Another major problem at the field level arises from the sequential applications of products, as if residues are retained in the spraying system. These residues can be released during the sequential application and cause damage to crops, especially in the case of herbicides.

### 2. Determination of the Potential for Reducing Waste Retention

In another test covering the determination of the potential for reducing residue retention, the objective was to evaluate the potential for improving the physical stability of the mixture with different adjuvants and quantify the residues retained at restriction points in the spraying circuit.

In the first treatment, two fungicides (0.4 L/ha)+(3.0 kg/ha)+insecticide (0.07 L/ha)+standard oil (0.25%) were mixed.

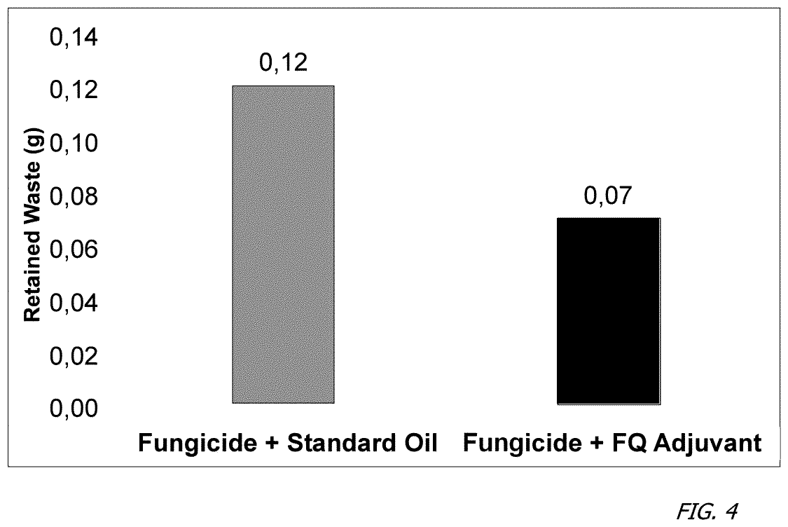

In the second treatment, the same two fungicides (0.4 L/ha)+(3.0 kg/ha)+insecticide (0.07 L/ha)+the FQ adjuvant formulation (0.12 L/ha) were mixed. Each treatment was added separately to a spray simulator, where they remained in circulation for two hours. After this period, the application was carried out. At the end of each application, the line filters (60 mesh) and nozzle filters (80 and 100 mesh) were removed from the simulator and placed in an oven at 40° C. for 15 minutes for subsequent weighing and quantification of residues retained in the system. According to the graph in FIG. 4, the treatment containing the new FQ adjuvant formulation promoted the reduction of waste linked to the products that make up the spray mixtures in the sprayer systems. To be precise, the proposed formulation reduced the amount of residue retained in the spraying system by 40%.

Finally, it is of great importance to achieve the target during phytosanitary application in agricultural crops, aiming at better functionality of the products' functions, especially in the lower third of the plants which, due to the closed canopy situation, presents ideal microclimatic conditions for the emergence of diseases due to high moisture retention, a factor known as one of the main factors in the germination of phytopathogenic agents and decreased light.

### 3. Target Achievement Test

In this sense, in a final test, the spray coverage potential was determined in order to discover the potential for improving the quality of application with different adjuvants based on the evaluation of coverage and distribution of drops in soybean crops.

In the first treatment, two fungicides (0.4 L/ha)+(3.0 kg/ha)+insecticide (0.07 L/ha)+standard oil (0.25%) were mixed.

In the second treatment, the same fungicides (0.4 L/ha)+(3.0 kg/ha)+insecticide (0.07 L/ha)+the new FQ adjuvant formulation (0.12 L/ha) were mixed.

In the third treatment, the same fungicides (0.4 L/ha)+(3.0 kg/ha)+insecticide (0.07 L/ha)+competing adjuvant (0.15 L/ha) were mixed.

The fluorescent marker was added to the proposed mixtures and applied to the soybean crop, for subsequent evaluation in a dark environment with black light, of the percentage of coverage on the plant surface and distribution in the upper, middle, and lower thirds.

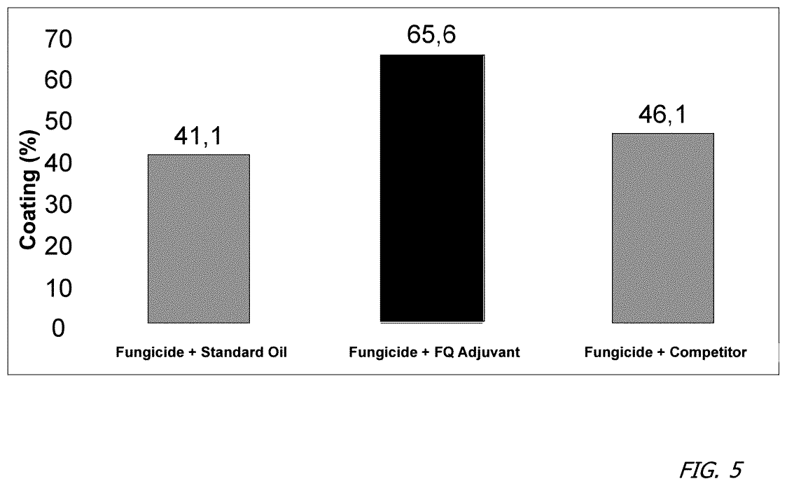

According to the graph in FIG. 5, the treatment containing the new FQ adjuvant formulation provided a higher percentage of target coverage, especially in the lower third of the plant. The emergence of diseases normally occurs in the lower third of the plant, which has a more favorable microclimate with greater humidity and lower incidence of light. In this sense, the product can provide a better disease management effect when applied with phytosanitary products.

### 4. Standard Test for Checking Agricultural Spray Residues in a Spraying Simulator Carried Out in Two Stages

### 4.1. Description of Spraying Simulator:

The simulator contains an application system with a 50 mesh main filter, a 50 mesh agitation filter, two 50 mesh line filters and a section with two nozzles where two spray tips are present, one with an 80 mesh filter and another with a 100 mesh filter.

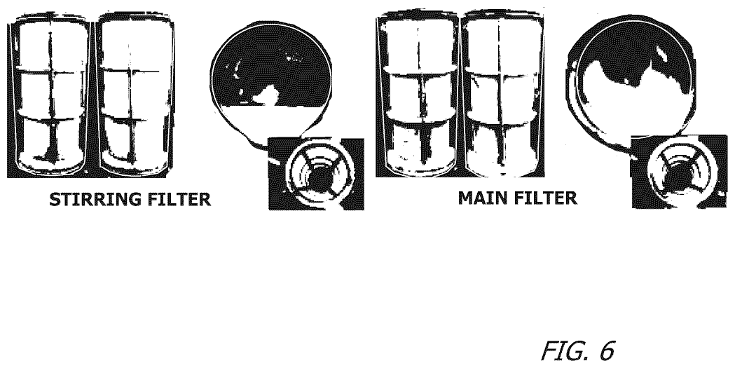

4.2. Applied grout (problematic pattern in relation to waste):
Compounds: Water+Perito+Unizeb Gold +Carbendazim Nortox+Fox SC.
Volume of syrup: 90 L
Application rate: 60 L/ha
Application pressure: 3 bar
Product doses: 1 kg/ha of Perito 970 SG, 1.5 kg/ha of Unizeb Gold, 0.6 L/ha of Carbendazim Nortox and 0.4 L/ha of Fox SC.
   a. Test steps
Step 1:
Application of the syrup without the addition of adjuvant.
Removal of the filters that make up the equipment for visual qualitative verification of the waste as shown in FIG. 6.
Documentation of results.
Cleaning the simulator: the filters were cleaned and placed back into the simulator. A solution with cleaning agent for a volume of 90 L of water was prepared and applied through the simulator. Next, the filters were removed and documented for visual qualitative verification of residues that might have remained in the sprayer system.
Removal of the filters that make up the equipment for visual qualitative verification of the waste.
Documentation of results.

### ·Step 2:

Application of the mixture with the addition of the proposed FQ adjuvant formulation.
With the simulator completely clean, the same process as in step 1 was carried out, but with the addition of the FQ adjuvant formulation.
The results of steps 1 and 2 were compared to verify the potential for reducing waste when using the new FQ adjuvant formulation.

### 5. Standard Test for Syrup Residues on a Laboratory Bench

In bench tests in the laboratory, it was also possible to evaluate the efficiency of the invention in relation to syrup conditioning, carrying out the following protocol:

| | | | |
|---|---|---|---|
| Protocol | | Dose | Dose |
| code | Mixture | (L/Kg)/ha | (mL/g)/L |

Water Temperature: 15° C.

| | | | |
|---|---|---|---|
| 3 | Formulation of FQ | 0.1 + 0.05 + | 1 + 0.5 + |
| | Adjuvant + | 0.5 + 1 + | 5 + 10 + |
| | Emulsifiable Oil + | 0.6 + 1 + 0.2 | 6 + 10 + 2 |
| | Herbicide + Native + | | |
| | Foliar Fertilizer + | | |
| | Liquid Inoculant | | |
| 5 | Formulation of FQ | 0.1 + 0.05 + | 1 + 0.5 + |
| | Adjuvant + | 1 + 0.6 + | 10 + 5 + |
| | Emulsifiable Oil + | 0.5 + 1 + 0.2 | 6 + 10 + 2 |
| | Herbicide + Native + | | |
| | Foliar Fertilizer + | | |
| | Liquid Inoculant | | |
| 7 | Herbicide + Nativo + | 1 + 0.6+ | 10 + 6 + |
| | Foliar fertilizer + | 1 + 0.2 | 10 + 2 |
| | Liquid inoculant | | |

The evaluation protocol demonstrating the pH and total mixture of the protocols is shown below:

Assessment Protocol

| | | | Full |
|---|---|---|---|
| Mixture | | pH | syrup |
| 3 | Formulation of FQ | 5/4.5/4.5/ /5/5/4/4 | 4 |
| | Adjuvant + Emulsifiable Oil + | | |
| | Herbicide + Native + Foliar | | |
| | Fertilizer + Liquid Inoculant | | |
| 5 | Formulation of FQ | 5/4.5/4.5/4.5/4.5/4/4 | 4 |
| | Adjuvant + Emulsifiable Oil + | | |
| | Herbicide + Native + Foliar | | |
| | Fertilizer + Liquid Inoculant | | |
| 7 | Herbicide + Native + Foliar | 5.5/5.5/4/4 | 4 |
| | fertilizer + Liquid inoculant | | |

The flow rate used was 100 L/h, following the procedure described below:

After adding the products from each protocol, the mixture was stirred in the Becker cup constantly for two minutes and the evaluation was carried out via a 100 mesh sieve. The results obtained were recorded through photos, before and after shaking. Once the recordings were completed, the mixture remained at rest for a period of two hours.

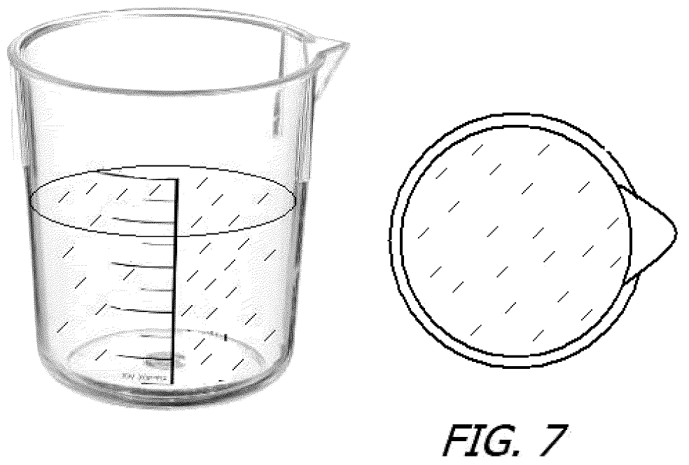

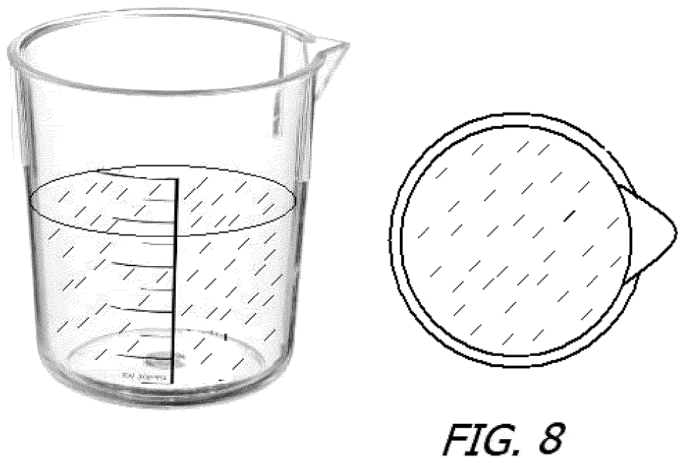

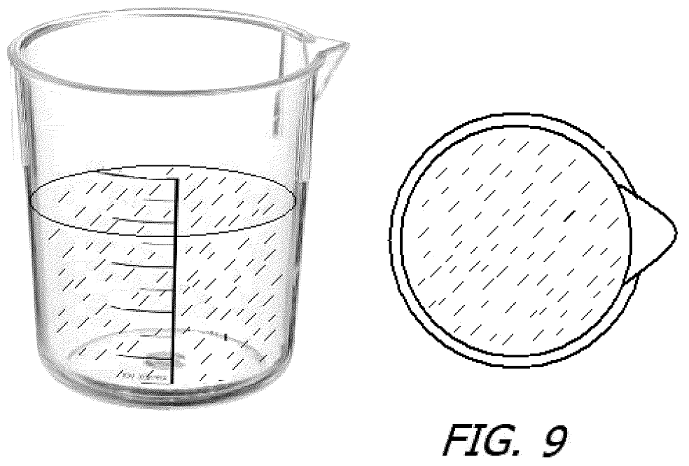

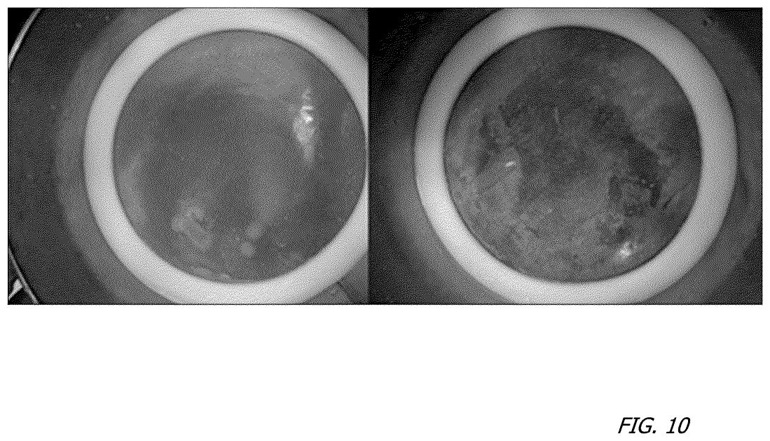

In FIGS. 7, 8 and 9 the mixtures of protocols 3, 5 and 7 are shown before and after agitation and in FIGS. 10, 11 and 12 the evaluations in the sieve after resting for two hours are shown.

FIG. 10 shows the residue from protocol 3 (FQ Adjuvant Formulation+Emulsifiable Oil+Herbicide+Native+Foliar Fertilizer+Liquid Inoculant) retained in the sieve before passing running water (image on the left) and after passing running water (image on the right).

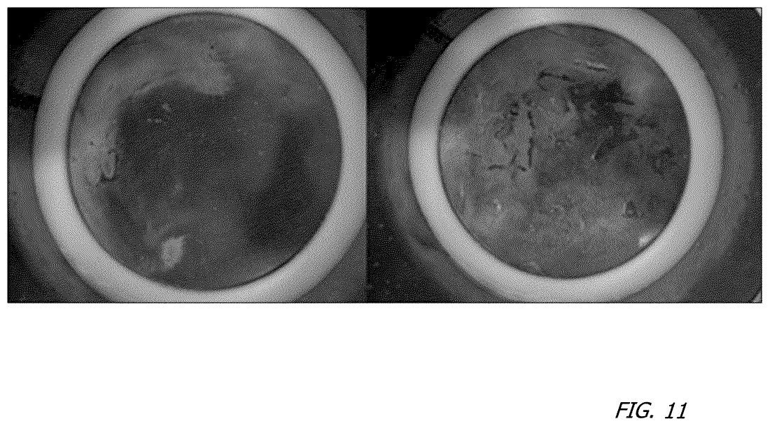

FIG. 11 represents the residue from protocol 5 (FQ Adjuvant Formulation+Emulsifiable Oil+Herbicide+Native+Foliar Fertilizer+Liquid Inoculant) retained in the sieve before the passage of running water (image on the left) and after the passage of running water (image on the right).

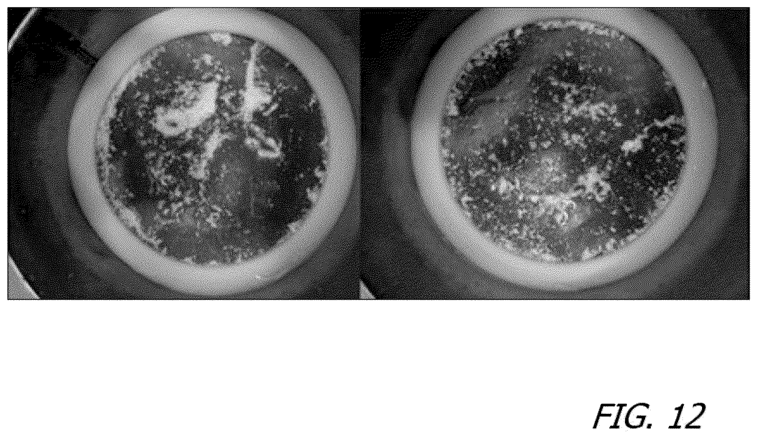

Finally, FIG. 12 shows the residue from protocol 7 (Herbicide+Native+Foliar fertilizer+Liquid inoculant) retained in the sieve before the passage of water (image on the left) and after the passage of water (image on the right).

Therefore, it can be noted that the new formulation of the FQ adjuvant in the spray mixture creates a synergistic effect, resulting from the combination of the characteristics of each component. This effect not only surpasses traditional adjuvants, but also offers additional benefits such as greater target coverage, especially in the lower third of the plant. Furthermore, it prevents the formation of lumps in the syrup and improves the recovery of viable cells, while other competing adjuvants cause the death of microorganisms.

Other benefits include improving the interaction between the phytosanitary products in the mixture, providing better fluidity of the syrup, reduction of problems with foam formations, increased operational efficiency of the sprayer, reduced interruptions for cleaning nozzles and filters, optimization of spray droplet deposition, with greater plant coverage; intensification of wettability, resulting in greater effectiveness of phytosanitary products in the spray solution; and also acts as a drift reducer, scale reducer, spreader and adhesion agent.

What is claimed is:

1. A low viscosity agricultural adjuvant for spraying syrups, comprising:
21% to 30% by weight of first grade emulsifying agents/surfactants;
18% to 25% by weight of second grade emulsifying agents/surfactants;
0.15% to 1.5% by weight xanthan gum suspending agent;
1.0% to 4.0% by weight of polydimethylsiloxane defoamer;
2.0% to 8% by weight of clays, and
32.8% to 56.5% by weight of water.

2. The low viscosity agricultural adjuvant for spraying syrups according to claim 1, wherein said second grade emulsifying agents/surfactants include 35% to 37% of ethoxylated fatty alcohol, 41% to 43% ethoxylated oil, and 20% to 22% linear alkylbenzene sulfonic acid.

3. The low viscosity agricultural adjuvant for spraying syrups according to claim 1, wherein said clays include 23% to 25% of sodium bentonites, 19% to 21% attapulgite, 37% to 39% sepiolite and 16% to 18% zeolite.

4. The low viscosity agricultural adjuvant for spraying syrups according to claim 1, wherein said first grade emulsifying agents/surfactants are selected from a group comprising triethanolamine lauryl ether sulfate, ethoxylated alcohol, ethoxylated fatty alcohol, ethoxylated oil and linear alkylbenzene sulfonic acid.

5. The low viscosity agricultural adjuvant for spraying syrups according to claim 1, wherein said second grade emulsifying agents/surfactants are selected from a group comprising ethoxylated fatty alcohol, ethoxylated oil, and linear alkylbenzene sulfonic acid.

6. The low viscosity agricultural adjuvant for spraying syrups according to claim 1, wherein said clays are selected from a group comprising of sodium bentonites, attapulgite, sepiolite and zeolite.
